(19) United States
(12) Patent Application Publication
(10) Pub. No.: US 2017/0252716 A1
(43) Pub. Date: Sep. 7, 2017

(54) SURFACE MODIFICATION AGENT FOR CONTROL OF DUST FROM ADDITIVE PARTICLES

(71) Applicant: Halliburton Energy Services, Inc., Houston, TX (US)

(72) Inventors: Philip D. Nguyen, Houston, TX (US); Loan Vo, Houston, TX (US); Corneliu Stanciu, Kingwood, TX (US); Timothy H. Hunter, Duncan, OK (US)

(21) Appl. No.: 15/515,976

(22) PCT Filed: Oct. 30, 2014
(86) PCT No.: PCT/US2014/063100

§ 371 Date: Mar. 30, 2017

(51) Int. Cl. B01J 2/30; C09K 8/80; C09K 8/035; C08L 33/26; B65D 47/06; C09K 8/03; C09K 3/22; C08L 33/24

(52) U.S. Cl. CPC B01J 2/30; C09K 3/22; C09K 8/805; C08L 33/24; C08L 33/26; B65D 47/06; C09K 8/03; C09K 8/032; C09K 8/035

(57) ABSTRACT

A system for transferring additive particles comprising: the additive particles; a storage container; and a surface modification agent, wherein at least some of the additive particles are treated with the surface modification agent, and wherein the surface modification agent reduces an amount of dust that is produced during transfer of the additive particles into the storage container, from the storage container, or into and from the storage container. A method of reducing an amount of dust produced during transfer of additive particles comprising: treating at least some of the additive particles with a surface modification agent; storing the additive particles; and transferring the additive particles prior to and after storage, wherein the surface modification agent reduces the amount of dust produced during at least one of the transfers of the additive particles.

### TECHNICAL FIELD

Additive particles can be used in a variety of industries to form treatment fluids. Dust can be produced when the additive particles are transferred. Dusting can be quite problematic and difficult to control efficiently.

### BRIEF DESCRIPTION OF THE FIGURES

The features and advantages of certain embodiments will be more readily appreciated when considered in conjunction with the accompanying figures. The figures are not to be construed as limiting any of the preferred embodiments.

FIG. 1 is a diagram illustrating a system for transferring additive particles from a storage container to one or more mixing vessels.

FIG. 2 is a photograph of untreated additive particles having air blown onto the particles.

FIG. 3 is a photograph of additive particles that were treated with a surface modification agent having air blown onto the particles.

### DETAILED DESCRIPTION OF THE INVENTION

There are a variety of industries that use additives that are prone to “dusting.” “Dusting” occurs when particles are transferred or moved and smaller particulates or dust get stirred up and remain in the air instead of moving into the new container or location. Dusting can be quite problematic.

In the oil and gas industry, for example, proppant can be used to prop fractures in an open position. A common proppant is sand. Sand is prone to dusting as the smaller silica particulates or dust tends to get stirred up into the air during transfer. The proppant is often stored in a storage container, such as a silo, so the proppant is on-hand and readily available at the work site when needed for oil and gas operations. Dusting can generally occur when transferring the proppant into the storage container or removing the proppant from the storage container for use in wellbore operations.

In order to combat the problems of dusting, a liquid, such as water can be sprayed onto the particles before and/or during transfer of the particles. The liquid can help weight down the smaller particulates of dust and keep them from becoming stirred up or airborne. Moreover, equipment, such as a vacuum, can be used to suck the dust out of the air.

However, some of the disadvantages to using a liquid to combat dusting is that the liquid can evaporate, which leaves the particulates susceptible to dusting during the next transfer. As a result, when a liquid is used, it is common to have to keep re-applying the liquid before or during each transfer of the particles. Additionally, equipment, such as a vacuum, can be expensive and cumbersome due to the physical size and handling of the equipment near the transfer area.

Therefore, there is a need and an ongoing industry-wide concern for being able to combat dusting problems when storing or transferring particle additives. It has been discovered that a surface modification agent can be used to treat additive particles. The surface modification agent can modify the surface of at least some of the particles in which particulates of dust can become stuck to or at least attracted to the particles such that the dust is less likely to become stirred up during transfer.

According to certain embodiments, a method of reducing an amount of dust produced during transfer of additive particles comprises: treating at least some of the additive particles with a surface modification agent; storing the additive particles; and transferring the additive particles prior to and after storage, wherein the surface modification agent reduces the amount of dust produced during at least one of the transfers of the additive particles.

According to certain other embodiments, a system for transferring additive particles comprises: the additive particles; a storage container; and a surface modification agent, wherein at least some of the additive particles are treated with the surface modification agent, and wherein the surface modification agent reduces an amount of dust that is produced during transfer of the additive particles into the storage container, from the storage container, or into and from the storage container.

It is to be understood that the discussion of preferred embodiments regarding the additive particles, the storage container, or the surface modification agent are intended to apply to the method and system embodiments.

The additive particles can be any additive in a dry form that is prone to dusting. The additive particles can be used in a variety of industries, including oil and gas, waste treatment, water treatment, mining, and construction. By way of example, the additive particles can be proppant for oil and gas wellbore operations. The proppant can be sand for example, which is prone to dusting. The additive particles can be bulk particles, mesoscopic particles, nanoparticles, or combinations thereof. As used herein, a “bulk particle” is a particle having a particle size greater than 1 micron. As used herein, a “mesoscopic particle” is a particle having a particle size in the range of 1 micron to 0.1 micron. As used herein, a “nanoparticle” is a particle having a particle size of less than 0.1 micron. As used herein, the term “particle size” refers to the volume surface mean diameter (“Dₛ”), which is related to the specific surface area of the particle. The volume surface mean diameter may be defined by the following equation: Dₛ=6/(ΦₛA_{w}ρₚ) where Φₛ=sphericity; A_{w}=specific surface area; and ρₚ=particle density. The additive can also include dust particulates.

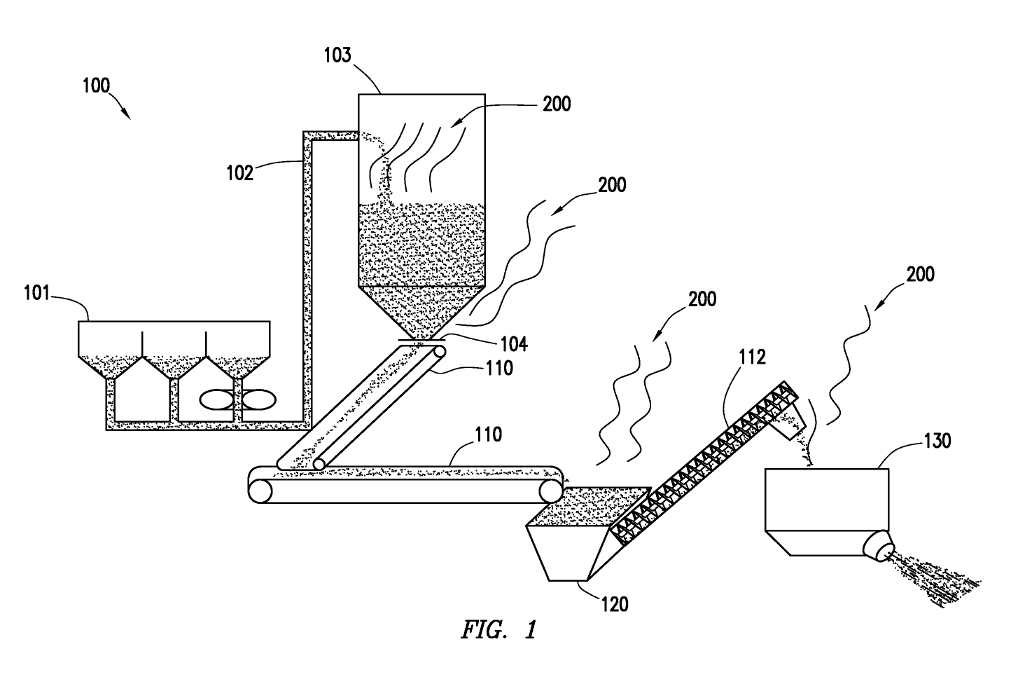

Turning to FIG. 1, the system 100 includes a storage container 103. The storage container 103 can be, for example, a silo or similar container that is capable of storing a large amount of the additive particles. The system 100 can further include a transport trailer 101. The transport trailer 101 can transport the additive to the storage container 103, for example, from a warehouse or manufacturing plant. The storage container 103 can be located at the work site where the additive is to be used. The storage container 103 containing the additive particles can also be transported to the work site. The additive can be transferred from the transport trailer 101 into the storage container 103 via a transfer device, such as a transfer tube 102, an open conveyor 110, or a closed conveyor 112. The additive can be prone to dusting during the transfer and create dust 200 outside or inside of the storage container 103.

The system 100 can also include one or more additional transfer devices, such as an open conveyor 110 (e.g., a conveyor belt) or a closed conveyor 112 (e.g., an auger screw device) to transfer the additive to one or more mixing apparatuses. By way of example, the additive can be gravity fed from the storage container 103 onto an open conveyor 110 by opening a gate valve 104 located at the bottom of the storage container 103. The additive can then be transferred via the open conveyor 110 into a dry ingredient mixing bin 120 where other dry ingredients can be mixed with the additive. The dry mixture can then be additionally transferred via a closed conveyor 112, for example, into a dry and wet ingredient mixing tub 130 or other similar device wherein the dry ingredients can be mixed with one or more fluids to form a treatment fluid. As used herein, a “fluid” is a substance having a continuous phase that tends to flow and to conform to the outline of its container when the substance is tested at a temperature of 71° F. (22° C.) and a pressure of 1 atmosphere “atm” (0.1 megapascals “MPa”). A fluid can be a liquid or gas.

As can be seen in FIG. 1, at each transfer point before and after being placed into the storage container 103 an amount of dust 200 can be produced. There can also be dust produced at every transfer point.

At least some of the additive particles are treated with a surface modification agent. The surface modification agent reduces the amount of dust produced during at least one of the transfers of the additive particles. The surface modification agent can alter at least a portion of the surface of at least some, a majority of, or all of the additive particles. The alteration can include imparting hydrophobic characteristics to the portion of the surfaces. This surface alteration can attract and possibly bind the dust particulates onto the additive particles that have been treated with the surface modification agent. In this manner, the amount of dust that is produced during a transfer of the additive particles can be reduced. The amount of dust can also be substantially reduced and possibly even eliminated.

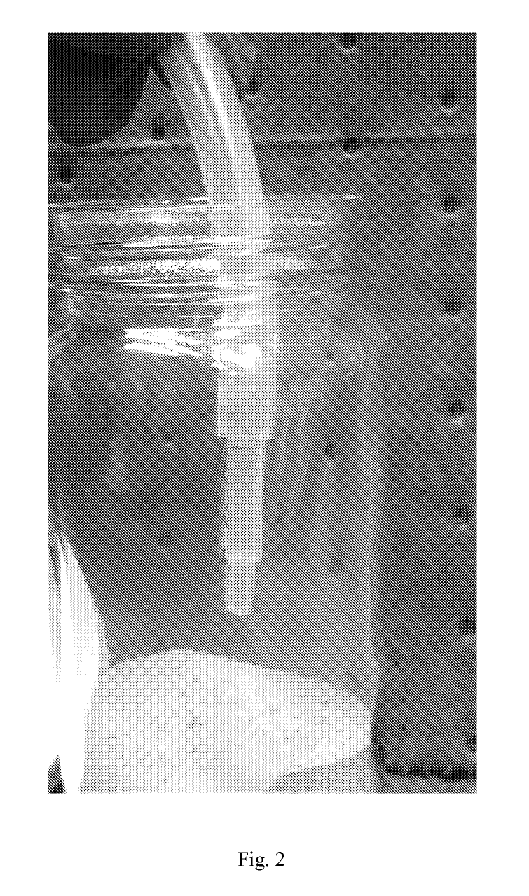

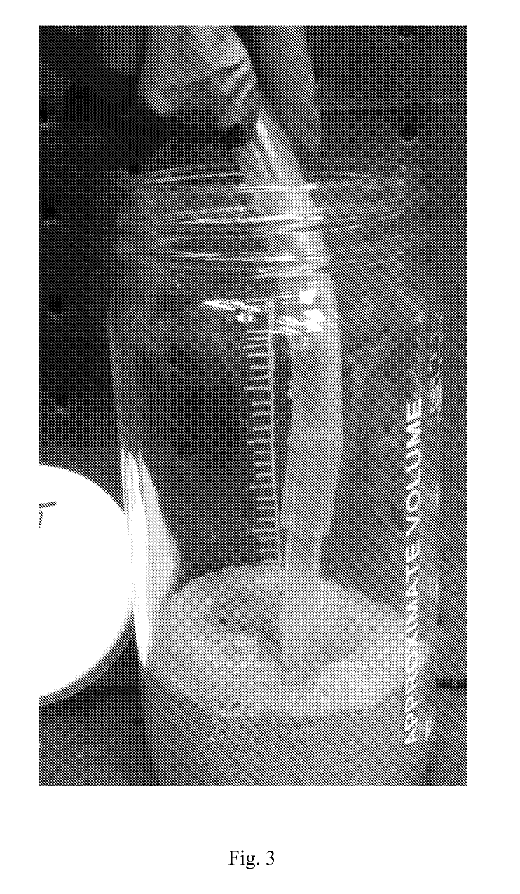

FIG. 2 is a photograph of sand additive particles that have not been treated with a surface modification agent; while FIG. 3 is a photograph of sand additive particles that have been treated with a surface modification agent. Both jars of additive particles were contacted with the same pressure of air blown onto the additive particles through a tube. As can be seen in FIG. 2, dust was produced when the untreated particles were contacted with the air. By contrast, as can be seen in FIG. 3, the additive particles that were treated with a surface modification agent did not produce any visible dust when contacted with the air. This indicates that the amount of dust can be drastically reduced and possibly eliminated by treating the additive particles with a surface modification agent.

The surface modification agent can be a polymer. A polymer is a large molecule composed of repeating units, typically connected by covalent chemical bonds. A polymer is formed from monomers. During the formation of the polymer, some chemical groups can be lost from each monomer. The piece of the monomer that is incorporated into the polymer is known as the repeating unit or monomer residue. The backbone of the polymer is the continuous link between the monomer residues. The polymer can also contain functional groups connected to the backbone at various locations along the backbone. Polymer nomenclature is generally based upon the type of monomer residues comprising the polymer. A polymer formed from one type of monomer residue is called a homopolymer. A copolymer is formed from two or more different types of monomer residues. The surface modification agent can be a hydrophobically-modified polyamine, polyimine, polyamide, polyester, or polyacrylate. The polymer can be hydrophobically modified wherein the hydrophobic portion of the polymer contains a carbon chain length in the range of C₆ to C₃₂. The carbon chain length can also be in the range of C₁₂ to C₂₂. The hydrophobic portion of the polymer can also be a tall oil fatty acid having the stated carbon chain length.

According to certain embodiments, the additive particles possess fluid-like properties prior to and after being treated with the surface modification agent. As used herein, the phrase “fluid-like properties” means that the additive particles can flow, be poured, free flow under the force of gravity, be pumped, and conform to the outline of a container. In this manner, the additive particles can be pumped, for example, from the transport trailer 101 and into the storage container 103. The additive particles can also flow from the storage container 103, for example by gravity feed, onto an open or closed conveyor. The surface modification agent can be in a concentration less than or equal to a necessary concentration such that the treated additive particles possess the fluid-like properties. For example, the surface modification agent can be in a concentration in the range of about 0.005% to about 5% volume by weight of the additive particles, or about 0.05% to about 1% volume by weight of the additive particles. The surface modification agent can also be in a sufficient concentration such that the amount of dust 200 produced is reduced to a desirable level during transfer.

The additive particles can be treated with the surface modification agent at a variety of times. By way of example, the additive particles can be treated at any time prior to a transfer in which dust is likely to be produced. The additive particles can be treated prior to, during, or after transfer into the storage container 103. By way of example, the additive particles can be treated at a manufacturing facility or when placed into the transport trailer 101. The additive particles can also be treated as the additive particles are being transferred into the storage container 103. By way of another example, the additive particles can be treated when leaving the storage container 103, for example during gravity feeding onto an open conveyor 110. The additive particles can also be treated before or after being transferred into a mixing apparatus, such as the dry ingredient mixing bin 120 or the dry and wet ingredient mixing tub 130, from the storage container. It may be advantageous to treat the additive particles as far up the chain as possible, for example prior to being transferred into the storage container 103 or upon exiting the storage container. In this manner, the amount of dust 200 that is produced is decreased as often as possible at each transfer point. This also eliminates the need to use other liquids, such as water, or equipment to try and reduce the amount of dust produced prior to treatment with the surface modification agent. As such, the additive particles can be treated once and the amount of dust produced during each subsequent transfer is reduced and possibly eliminated.

The methods include transferring the additive particles prior to and after storage. The additive particles can be transferred directly into the storage container 103 in a manufacturing or supplier's building. The storage container 103 can then be transported to a work site. Alternatively, the additive particles can be transferred into the storage container 103 at the work site. The additive particles can then be stored in the storage container. The additive particles can be stored for a desired length of time prior to transfer or use. The desired amount of time can range from about several hours to several months. The additive particles can also be transferred from the storage container 103 directly into a mixing vessel or into one or more mixing vessels via a conveyor or transfer tube.

The methods can further include using the treated additive particles in an operation at the work site. The operation can be an oil and gas operation. The operation can be, for example, a cementing or fracturing operation. The additive particles can be proppant. The proppant can be sand.

Some of the advantages to treating the additive particles with the surface modification agent are that the particles only have to be treated one time because the surface modification agent does not evaporate like other liquids, the surface modification agent is stable at temperatures up to 350° F. (177° C.) for several days to months without degrading or oxidizing, and cumbersome equipment is not needed to combat the production of dust during transfers.

The exemplary fluids and additives disclosed herein may directly or indirectly affect one or more components or pieces of equipment associated with the preparation, delivery, recapture, recycling, reuse, and/or disposal of the disclosed fluids and additives. For example, the disclosed fluids and additives may directly or indirectly affect one or more mixers, related mixing equipment, mud pits, storage facilities or units, fluid separators, heat exchangers, sensors, gauges, pumps, compressors, and the like used to generate, store, monitor, regulate, and/or recondition the exemplary fluids and additives. The disclosed fluids and additives may also directly or indirectly affect any transport or delivery equipment used to convey the fluids and additives to a well site or downhole such as, for example, any transport vessels, conduits, pipelines, trucks, tubulars, and/or pipes used to fluidically move the fluids and additives from one location to another, any pumps, compressors, or motors (e.g., topside or downhole) used to drive the fluids and additives into motion, any valves or related joints used to regulate the pressure or flow rate of the fluids, and any sensors (i.e., pressure and temperature), gauges, and/or combinations thereof, and the like. The disclosed fluids and additives may also directly or indirectly affect the various downhole equipment and tools that may come into contact with the fluids and additives such as, but not limited to, drill string, coiled tubing, drill pipe, drill collars, mud motors, downhole motors and/or pumps, floats, MWD/LWD tools and related telemetry equipment, drill bits (including roller cone, PDC, natural diamond, hole openers, reamers, and coring bits), sensors or distributed sensors, downhole heat exchangers, valves and corresponding actuation devices, tool seals, packers and other wellbore isolation devices or components, and the like.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present invention.

As used herein, the words “comprise,” “have,” “include,” and all grammatical variations thereof are each intended to have an open, non-limiting meaning that does not exclude additional elements or steps. While compositions and methods are described in terms of “comprising,” “containing,” or “including” various components or steps, the compositions and methods also can “consist essentially of” or “consist of” the various components and steps. Whenever a numerical range with a lower limit and an upper limit is disclosed, any number and any included range falling within the range is specifically disclosed. In particular, every range of values (of the form, “from about a to about b,” or, equivalently, “from approximately a to b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

What is claimed is:

1. A method of reducing an amount of dust produced during transfer of additive particles comprising:
treating at least some of the additive particles with a surface modification agent;
storing the additive particles; and
transferring the additive particles prior to and after storage, wherein the surface modification agent reduces the amount of dust produced during at least one of the transfers of the additive particles.

2. The method according to claim 1, wherein the additive particles are bulk particles, mesoscopic particles, nanoparticles, or combinations thereof.

3. The method according to claim 1, wherein the additive further comprises dust particulates.

4. The method according to claim 1, wherein the surface modification agent alters at least a portion of the surface of at least some of the additive particles.

5. The method according to claim 4, wherein the alteration imparts hydrophobic characteristics to the portion of the surfaces.

6. The method according to claim 5, wherein the surface modification agent is a hydrophobically-modified polyamine, polyimine, polyamide, polyester, or polyacrylate.

7. The method according to claim 6, wherein the hydrophobic portion of the polymer contains a carbon chain length in the range of C₆ to C₃₂.

8. The method according to claim 6, wherein the hydrophobic portion of the polymer is a tall oil fatty acid having a carbon chain length in the range of C₆ to C₃₂.

9. The method according to claim 1, wherein the additive particles possess fluid-like properties prior to and after being treated with the surface modification agent.

10. The method according to claim 1, wherein the surface modification agent is in a concentration in the range of about 0.005% to about 5% volume by weight of the additive particles.

11. The method according to claim 1, further comprising transferring the additive particles into a storage container prior to the step of storing.

12. The method according to claim 11, wherein the additive particles are treated prior to, during, or after transfer into the storage container.

13. The method according to claim 1, further comprising transferring the additive particles to one or more mixing apparatuses after the step of storing.

14. The method according to claim 1, further comprising using the treated additive particles in an operation at a work site.

15. The method according to claim 14, wherein the operation is an oil and gas operation.

16. The method according to claim 15, wherein the operation is a hydraulic fracturing operation and the additive particles are proppant.

17. The method according to claim 16, wherein the proppant is sand.

18. A system for transferring additive particles comprising:
the additive particles;
a storage container; and
a surface modification agent, wherein at least some of the additive particles are treated with the surface modification agent, and wherein the surface modification agent reduces an amount of dust that is produced during transfer of the additive particles into the storage container, from the storage container, or into and from the storage container.

19. The system according to claim 18, wherein the system further comprises a transfer device to transfer the additive particles to the storage container or to one or more mixing apparatuses.

20. The system according to claim 18, wherein the surface modification agent is in a concentration in the range of about 0.005% to about 5% volume by weight of the additive particles.
